(19) United States
(12) Patent Application Publication
(10) Pub. No.: US 2010/0240365 A1
(43) Pub. Date: Sep. 23, 2010

(54) WIRELESS COMMUNICATION SYSTEMS WITH FEMTO NODES

(75) Inventor: Jen Mei Chen, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/728,603

(22) Filed: Mar. 22, 2010

Related U.S. Application Data
(60) Provisional application No. 61/162,612, filed on Mar. 23, 2009.

(51) Int. Cl. H04W 36/00

(52) U.S. Cl. 455/434

(57) ABSTRACT

Systems and methods for using a list of physical layer identifiers to efficiently read system information from a plurality of communication nodes are described herein. According to the systems and methods herein, the list of physical layer identifiers may be used to aid in the processes of manual selection of femto nodes, active handover, and/or idle cell reselection.

### CLAIM OF PRIORITY UNDER 35 U.S.C. §119

The present application for patent claims priority to U.S. Provisional Application No. 61/162,612, entitled “METHOD AND APPARATUS TO ENABLE USE OF A PSC LIST FOR EFFICIENT SYSTEM INFORMATION BROADCAST (SIB) READING,” filed Mar. 23, 2009. The above-referenced application is hereby expressly incorporated by reference herein.

### BACKGROUND

1. Field

The present application relates generally to wireless communication, and more specifically to systems and methods for using a list of physical layer identifiers to efficiently read system information from a plurality of communication nodes.

2. Background

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

In addition to mobile phone networks currently in place, a new class of small base stations has emerged, which may be installed in a user's home and provide indoor wireless coverage to mobile units using existing broadband Internet connections. Such personal miniature base stations are generally known as access point base stations, or, alternatively, Home Node B (HNB) or femto nodes. Typically, such miniature base stations are connected to the Internet and the mobile operator's network via a DSL router or a cable modem. Multiple femto nodes may be deployed by individual users in the coverage area of a traditional macro node. A mobile unit searching for femto nodes, such as for purposes of manual selection of a femto node or hand-off to a femto node, may search for and read system information of a plurality of femto nodes. Due to the large number of nodes in a given area, this may require a significant amount of time, during which the mobile unit's resources are unavailable for other purposes. Increasing the efficiency of the search for and reading of system information of femto nodes is desirable.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include identifying a plurality of nodes using limited resources.

One aspect of the disclosure is a wireless communication device. The wireless communication device comprises a transceiver. The transceiver is configured to store data indicative of physical identifiers of one or more femto nodes. The transceiver is further configured to scan one or more frequencies for transmissions from one or more nodes, the transmission comprising physical identifiers of the one or more nodes. The wireless communication device further comprises a processor. The processor is configured to identify a type of each of the one or more nodes based at least in part on said data and the physical identifiers of the one or more nodes. The processor is further configured to selectively and based on the identified types control the transceiver to read system information messages from the one or more nodes that are identified as femto nodes.

Another aspect of this disclosure is a method for communicating in a wireless network. The method comprises storing data indicative of physical identifiers of one or more femto nodes. The method further comprises scanning one or more frequencies for transmissions from one or more nodes, the transmission comprising physical identifiers of the one or more nodes. The method further comprises identifying a type of each of the one or more nodes based at least in part on said data and the physical identifiers of the one or more nodes. The method further comprises selectively and based on the identified types read system information messages from the one or more nodes that are identified as femto nodes.

Yet another aspect of this disclosure is a wireless communication device. The wireless device comprises means for storing data indicative of physical identifiers of one or more femto nodes. The wireless device further comprises means for scanning one or more frequencies for transmissions from one or more nodes, the transmission comprising physical identifiers of the one or more nodes. The wireless device further comprises means for identifying a type of each of the one or more nodes based at least in part on said data and the physical identifiers of the one or more nodes. The wireless device further comprises means for selectively and based on the identified types controlling the means for receiving to read system information messages from the one or more nodes that are identified as femto nodes.

Another aspect of this disclosure is a computer program product comprising computer-readable medium. The computer-readable medium comprises code for causing a computer to store data indicative of physical identifiers of one or more femto nodes. The computer-readable medium further comprises code for causing a computer to scan one or more frequencies for transmissions from one or more nodes, the transmission comprising physical identifiers of the one or more nodes. The computer-readable medium further comprises code for causing a computer to identify a type of each of the one or more nodes based at least in part on said data and the physical identifiers of the one or more nodes. The computer-readable medium further comprises code for causing a computer to selectively and based on the identified types read system information messages from the one or more nodes that are identified as femto nodes.

### BRIEF DESCRIPTION OF THE DRAWINGS

FIG. 1 illustrates an exemplary wireless communication network.

FIG. 2 illustrates exemplary interoperations of two or more communication networks.

FIG. 3 illustrates exemplary coverage areas of the wireless communication networks shown in FIGS. 1 and 2.

FIG. 4 is a functional block diagram of a first exemplary femto node and a first exemplary user equipment in one of the communication networks of FIG. 2.

FIG. 5 is a functional block diagram of a second exemplary femto node in one of the communication networks of FIG. 2.

FIG. 6 is a functional block diagram of a second exemplary user equipment in one of the communication networks of FIG. 2.

FIG. 7 is a functional block diagram of an exemplary macro node in one of the communication networks of FIG. 2.

FIG. 8 is a functional block diagram of a third exemplary user equipment in one of the communication networks of FIG. 2.

FIG. 9 is a flow chart illustrating an exemplary process of a user equipment with a femto cell subscription searching for femto nodes shown in FIGS. 4 and 5.

FIG. 10 is a flow chart illustrating an exemplary process of a user equipment in idle mode without a femto cell subscription searching for nodes shown in FIG. 7.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

In some aspects the teachings herein may be employed in a network that includes macro scale coverage (e.g., a large area cellular network such as a 3G networks, typically referred to as a macro cell network) and smaller scale coverage (e.g., a residence-based or building-based network environment). As a user equipment (“UE”) moves through such a network, the user equipment may be served in certain locations by access nodes (“ANs”) that provide macro coverage while the user equipment may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, and so on.

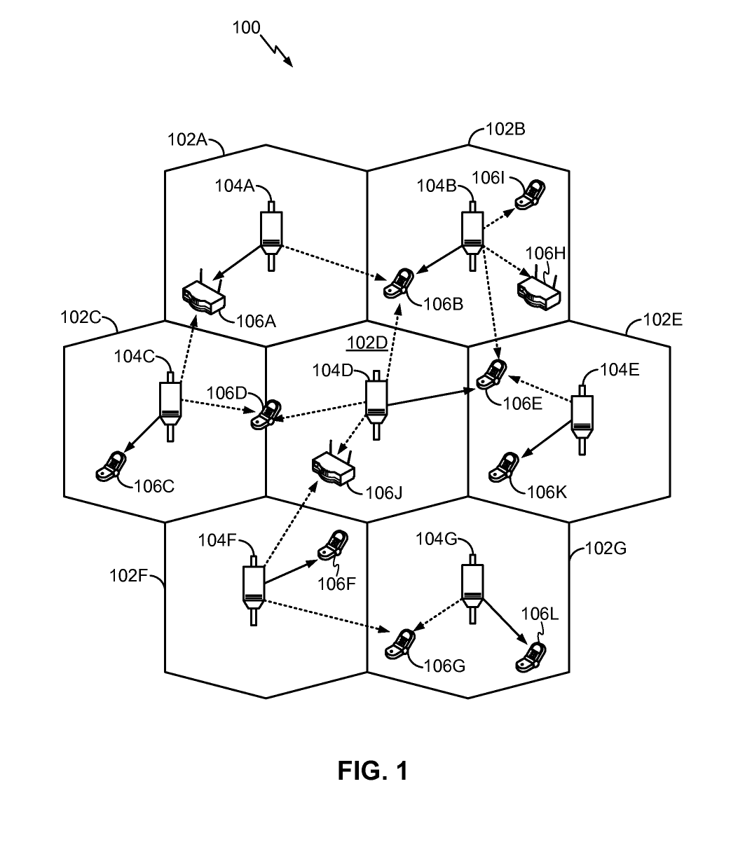

FIG. 1 illustrates an exemplary wireless communication network 100. The wireless communication network 100 is configured to support communication between a number of users. The wireless communication network 100 may be divided into one or more cells 102, such as, for example, cells 102a-102g. Communication coverage in cells 102a-102g may be provided by one or more nodes 104, such as, for example, nodes 104a-104g. Each node 104 may provide communication coverage to a corresponding cell 102. The nodes 104 may interact with a plurality of user equipments (UEs), such as, for example, UEs 106a-1061.

Each UE 106 may communicate with one or more nodes 104 on a forward link (FL) and/or a reverse link (RL) at a given moment. A FL is a communication link from a node to a UE. A RL is a communication link from a UE to a node. The nodes 104 may be interconnected, for example, by appropriate wired or wireless interfaces and may be able to communicate with each other. Accordingly, each UE 106 may communicate with another UE 106 through one or more nodes 104. For example, the UE 106j may communicate with the UE 106h as follows. The UE 106j may communicate with the node 104d. The node 104d may then communicate with the node 104b. The node 104b may then communicate with the UE 106h. Accordingly, a communication is established between the UE 106j and the UE 106h.

The wireless communication network 100 may provide service over a large geographic region. For example, the cells 102a-102g may cover only a few blocks within a neighborhood or several square miles in a rural environment. In one embodiment, each cell may be further divided into one or more sectors (not shown).

As described above, a node 104 may provide a user equipment (UE) 106 access within its coverage area to a communications network, such as, for example the internet or a cellular network.

A UE 106 may be a wireless communication device (e.g., a mobile phone, router, personal computer, server, etc.) used by a user to send and receive voice or data over a communications network. A user equipment (UE) may also be referred to herein as an access terminal (AT), as a mobile station (MS), or as a terminal device. As shown, UEs 106a, 106h, and 106j comprise routers. UEs 106b-106g, 106i, 106k, and 106l comprise mobile phones. However, each of UEs 106a-1061 may comprise any suitable communication device.

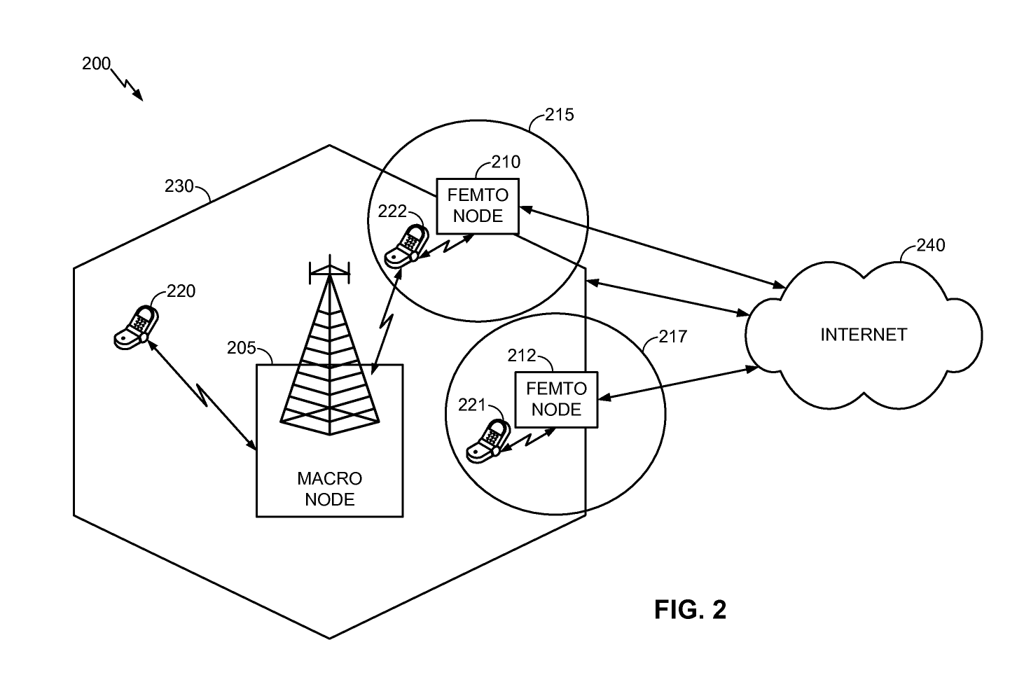

FIG. 2 illustrates exemplary interoperations of two or more communication networks. It may desirable for a UE 220 to transmit information to and receive information from another UE such as UE 221. FIG. 2 illustrates a manner in which the UEs 220, 221, and 222 may communicate with each other. As shown in FIG. 2, the macro node 205 may provide communication coverage to user equipments within a macro area 230. For example, the UE 220 may generate and transmit a message to the macro node 205. The message may comprise information related to various types of communication (e.g., voice, data, multimedia services, etc.). The UE 220 may communicate with the macro node 205 via a wireless link. The macro node 205 may communicate with a network 240 via a wired link or via a wireless link. The femto nodes 210 and 212 may also communicate with the network 240 via a wired link or via a wireless link. The UE 222 may communicate with the femto node 210 via a wireless link and the UE 221 may communicate with the femto node 212 via a wireless link.

The macro node 205 may also communicate with devices such as servers (not shown in FIG. 2) and switching centers (not shown in FIG. 2) through the network 240. For example, the macro node 205 may transmit the message received from the UE 220 to a switching center (not shown in FIG. 2), which may forward the message to another network. The network 240 may also be used to facilitate communication between the UEs 220, 221, and 222. For example, the UE 220 may be in communication with the UE 221. The UE 220 may transmit a message to the macro node 205. The macro node 205 may forward the message to the network 240. The network 240 may forward the messages to the femto node 212. The femto node 212 may forward the message to the UE 221. Similarly, the reverse path may be followed from the UE 221 to the UE 220. In another example, the UE 221 may be in communication with the UE 222. The UE 221 may transmit a message to the femto node 212. The femto node 212 may forward the message to the network 240. The network 240 may forward the message to the femto node 210. The femto node 210 may forward the message to the UE 222. Similarly, the reverse path may be followed from the UE 222 to the UE 221.

In one embodiment, the femto nodes 210, 212 may be deployed by individual consumers and placed in homes, apartment buildings, office buildings, and the like. The femto nodes 210, 212 may communicate with the UEs in a predetermined range (e.g., 100 m) of the femto nodes 210, 212 utilizing a predetermined cellular transmission band.

In one embodiment, the femto nodes 210, 212 may communicate with the network 240 by way of an Internet Protocol (IP) connection, such as a digital subscriber line (DSL, e.g., including asymmetric DSL (ADSL), high data rate DSL (HDSL), very high speed DSL (VDSL), etc.), a TV cable carrying Internet Protocol (IP) traffic, a broadband over power line (BPL) connection, or other link.

The network 240 may comprise any type of electronically connected group of computers and/or devices including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), or Bluetooth (IEEE 802.15.1). Note that computing devices may be desktop, server, portable, hand-held, set-top, or any other desired type of configuration. As used herein, the network 240 includes network variations such as the public Internet, a private network within the Internet, a secure network within the Internet, a private network, a public network, a value-added network, an intranet, and the like. In certain embodiments, network 240 may also comprise a virtual private network (VPN).

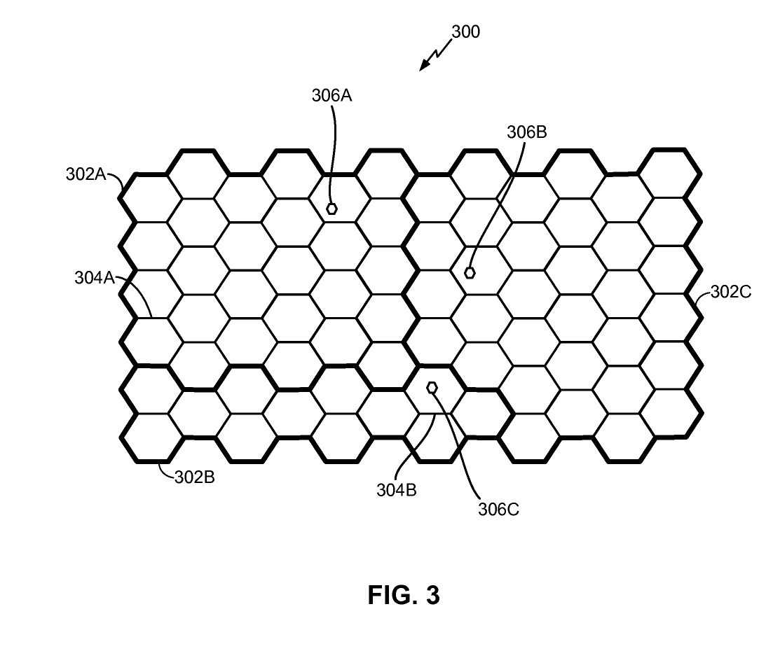

FIG. 3 illustrates exemplary coverage areas of the wireless communication networks 100 and 200 shown in FIGS. 1 and 2. The coverage area 300 may comprise one or more geographical areas in which the UE 220 may access the communication network 240 as discussed above with respect to FIG. 2. As shown the coverage area 300 comprises several tracking areas 302 (or routing areas or location areas). Each tracking area 302 comprises several macro areas 304, which may be similar to the macro area 230 described above with respect to FIG. 2. Here, areas of coverage associated with tracking areas 302A, 302B, and 302C are shown as delineated by wide lines as and the macro areas 304 are represented by hexagons. The tracking areas 302 may also comprise femto areas 306, which may be similar to the femto area 230 described above with respect to FIG. 2. In this example, each of the femto areas 306 (e.g., femto area 306C) is depicted within a macro area 304 (e.g., macro area 304B). It should be appreciated, however, that a femto area 306 may not lie entirely within a macro area 304. In practice, a large number of femto areas 306 may be defined with a given tracking area 302 or macro area 304. Also, one or more pico areas (not shown) may be defined within a given tracking area 302 or macro area 304.

Referring again to FIG. 2, the owner of the femto node 210 may subscribe to a mobile service, such as, for example, 3G mobile service, offered through the communication network 240 (e.g., a mobile operator core network). In addition, a user equipment 221 may be capable of operating both in macro environments (e.g., macro areas) and in smaller scale (e.g., residential, femto areas, pico areas, etc.) network environments. In other words, depending on the current location of the user equipment 221, the user equipment 221 may access the communication network 240 by a macro node 205 or by any one of a set of femto nodes (e.g., femto nodes 210, 212). For example, when a subscriber is outside his home, he may be served by a macro node (e.g., node 205) and when the subscriber is at home, he may be served by a femto node (e.g., node 210). It should further be appreciated that the femto nodes 210 may be backward compatible with existing user equipments 221.

The femto node 210 may communicate over a single frequency or, in the alternative, over multiple frequencies. Depending on the particular configuration, the single frequency or one or more of the multiple frequencies may overlap with one or more frequencies used by a macro node (e.g., node 205).

In one embodiment, a user equipment 221 may be configured to connect to a particular (e.g., preferred) femto node (e.g., a home femto node of the user equipment 221) whenever the user equipment 221 is within communication range of the femto node. For example, the user equipment 221 may communicate with only the femto node 210 when the user equipment 221 is within the femto area 215.

In another embodiment, the user equipment 221 is communicating with a node but is not communicating with a preferred node (e.g., as defined in a preferred roaming list). In this embodiment, the user equipment 221 may continue to search for a preferred node (e.g., the preferred femto node 210) using a Better System Reselection (“BSR”). The BSR may comprise a method comprising a periodic scanning of available systems to determine whether better systems are currently available. The BSR may further comprise attempting to associate with available preferred systems. The user equipment 221 may limit the BSR to scanning over one or more specific bands and/or channels. Upon discovery of a preferred femto node 210, the user equipment 221 selects the femto node 210 for communicating with to access the communication network 240 within the femto area 215.

For example, when the UE 221, which may be communicating with the macro node 205, gets close to the femto node 210, it may handoff (i.e., idle or active handoff) to the femto node 210. Accordingly, the UE 222 begins communicating with the femto node 210. In mobile networks such as 1xRTT, 1xEV-DO, WCDMA, HSPA, etc., when a user equipment gets close to a node, there are mechanisms to trigger the handoff. For example, each node (e.g., femto node, macro node, etc.) may be configured to generate and transmit a beacon. The beacon may comprise pilot channels and other overhead channels. Further, the beacon may be transmitted on multiple frequencies such that UEs operating on different frequencies can detect the beacon. The UE may use the beacon received from a node to identify the node for purposes of performing a handoff.

A user equipment (e.g., UE 220, 221, 222) may need to uniquely identify a femto node to determine whether or not to communicate with the femto node to access the communication network 240. For example, before the UE 221 can communicate with the femto node 210, it must be able to differentiate the femto node 210 from other nodes in the area. By identifying the femto node 210 uniquely, the UE 221 can appropriately direct communications to the femto node 210 and identify communications as originating from the femto node 210.

In one embodiment, a UE may uniquely identify a femto node by detecting a beacon comprising pilot signals transmitted from the femto node. The pilot signals may uniquely identify the femto nodes from which they were transmitted. For example, femto nodes 210 and 212 may each transmit a different pilot signal (e.g., pilot signal A and pilot signal B). The UE 221 may receive both pilot signals from each of the femto nodes 210 and 212. The UE 221 may then generate a pilot strength measurement report (PSMR). The PSMR may comprise the received pilot signals. The PSMR may further comprise the signal strength (E_{cp}/Iₒ) of the pilot signals. The UE 221 may transmit the PSMR in a measurement report message (MRM) to the macro node 205 with which it is communicating.

The macro node 205 may access information (e.g., a database) that maps the pilot signal to the femto node. In one embodiment, the information mapping pilot signals to nodes may be stored at the macro node 205. In another embodiment, the macro node 205 may access a server on the network 240 which includes the information mapping pilot signals to nodes. In one embodiment, if the UE 221 is provisioned to communicate with the identified femto node, the macro node 205 may direct the UE 221 to handoff to the identified femto node. In another embodiment, the macro node 205 further determines if the signal strength of the pilot signal is above a threshold level before directing a handoff.

In one embodiment, each pilot signal comprises a physical layer identifier, such as an offset pseudo noise (PN) short code. The offset PN short code may comprise a code or sequence of numbers (e.g., chips) that identifies the node and/or the node type (e.g., femto node, macro node, pico node). The offset PN short code may comprise a PN short code with a PN offset applied. The PN offset may indicate the delay from the true network synchronization time applied to a PN short code. In one embodiment, all of the nodes may use the same PN short code. However, a different PN offset may be applied to the PN short code for different nodes. Thus, the PN offset directly correlates to the offset PN short code and the terms “PN offset” and “offset PN short code” may be used interchangeably herein.

In one embodiment, the increment of delay between each PN offset is 64 chips. This ensures that received pilot signals are distinguishable. For example, when sending a pilot signal between the femto node 210 and the UE 221, there may be delay in the signal due to propagation delay over the communication path between the femto node 210 and the UE 221. Therefore a pilot signal with a PN offset of 64 sent by the femto node 210 may be delayed by 2 chips due to propagation delay and may be received as a PN offset of 66 by the UE 221. The UE 221 may search in a search window around the expected PN offset value to detect delayed pilot signals. For example, the UE 221 may have a search window of ±10 chips around the PN offset 64 to detect a delayed pilot signal. Since the offset of 66 is closer to the offset of 64 than any other pilot signal, it is safe to assume that the original pilot signal was sent with an offset of 64. Accordingly, by separating each pilot signal by at least 64 chips, small delays due to propagation delay do not affect detection of the pilot signal or identification of the transmitting node.

In one embodiment, the PN offset may be used to identify the type of node (e.g., femto node, macro node, pico node) transmitting signals. For example, a particular set of PN offsets may be reserved for identifying femto nodes. However, the number of PN offsets available for use may be smaller than the number of femto nodes within a geographic area. Thus the PN offset alone may not be sufficient to uniquely identify a femto node. For example, 6 unique PN offsets may be set aside for use by femto nodes. However, there may be more than 6 femto nodes deployed within the macro area 230. As a result, identifying each femto node using a single pilot signal with a given PN offset may not be sufficient to uniquely identify the femto node.

In one embodiment, a node may only provide certain services to certain user equipments with which it is provisioned to communicate. Such a node may be referred to as a “restricted” or “closed” node. In wireless communication networks comprising restricted femto nodes, a given user equipment may only be served by macro nodes and a defined set of femto nodes (e.g., the femto node 210). In other embodiments, a node may be restricted to not provide at least one of: signaling, data access, registration, paging, or service.

In one embodiment, a restricted femto node (which may also be referred to as a Closed Subscriber Group Home NodeB) is one that provides service to a restricted provisioned set of user equipments. This set may be temporarily or permanently changed to include additional or fewer user equipments as necessary. In some aspects, a Closed Subscriber Group (“CSG”) may be defined as the set of access nodes (e.g., femto nodes) that share a common access control list of user equipments (e.g., a list of the restricted provisioned set of user equipments). A channel on which all femto nodes (or all restricted femto nodes) in a region operate may be referred to as a femto channel.

Various relationships may thus exist between a given femto node and a given user equipment. For example, from the perspective of a user equipment, an open femto node may refer to a femto node with no restricted association. A restricted or closed femto node may refer to a femto node that is restricted in some manner (e.g., restricted for association and/or registration). A hybrid femto node may refer to a femto node where a limited amount of the femto nodes resources are available to all users, while the rest are operated in a restricted manner. A home femto node may refer to a femto node on which the user equipment is subscribed to/authorized to access and operate on. A guest femto node may refer to a femto node on which a user equipment is temporarily subscribed to/authorized to access or operate on. An alien femto node may refer to a femto node on which the user equipment is not authorized to access or operate on, except for perhaps emergency situations (e.g., 911 calls).

From a restricted femto node perspective, a home user equipment may refer to a user equipment that is subscribed to/authorized to access the restricted femto node. A guest user equipment may refer to a user equipment with temporary subscription/access to the restricted femto node. An alien user equipment may refer to a user equipment that does not have permission to access the restricted femto node, except for perhaps emergency situations, such as 911 calls.

In order to determine whether or not UE 221 is allowed to access the femto node 210, the UE 221 may read L3 overhead messages such as system information broadcasts (SIBs) of the femto node 210, which the femto node 210 may periodically broadcast. The system information may include identity information such as a CSG ID and/or a cell ID, which uniquely identify the femto node 210. The system information may further include an indicator of the access mode of the femto node 210 (e.g., closed, open, or hybrid). Accordingly, the UE 221 can determine whether it can access the femto node 210 and also how to uniquely identify the femto node 210.

In some embodiments each UE (e.g., UE 221) has information regarding the physical layer identifiers (e.g., primary scrambling codes (PSCs), physical cell identifiers (PCIs), PN offsets, etc.) reserved for use by femto nodes (e.g., femto node 210) on one or more frequencies. The information may comprise one or more physical identifier lists such as one or more PSC lists comprising physical layer identifiers that are reserved for use by femto nodes on one or more frequencies. The physical identifier list may further comprise the frequency of each of the femto nodes associated with the physical layer identifiers of the femto nodes. In one embodiment, a physical layer identifier list is unique to a particular frequency and lists the physical identifiers of femto nodes associated with only one frequency. In another embodiment, the physical identifier list lists the physical identifiers of femto nodes for all frequencies over which the UE 221 communicates.

The UE 221 may receive the physical identifier list from a node such as the macro node 205 or the femto node 210 when the UE 221 is in a standby or idle mode where it is not actively communicating such as in a voice call. In another embodiment, the UE 221 may be programmed (e.g., provisioned) with the physical identifier list. In one embodiment, the physical identifiers listed in a physical identifier list broadcast by the macro node 205 are of femto nodes communicating over the same frequency as the macro node 205 broadcast the list. In another embodiment, the physical identifiers listed in a physical identifier list broadcast by the macro node 205 are of femto nodes for all frequencies over which the UE 221 communicates.

Using the physical identifier list, the UE 221 searching for a femto node may read SIBs of only femto nodes, by only reading SIBs of nodes with a physical layer identifier on the physical layer identifier list and avoiding reading SIBs of other types of nodes. Certain resources (e.g., a transceiver, a processor, etc.) of the UE 221 may be used for reading SIBs. During this time, the UE 221 may be unable to use such resources for other purposes, such as receiving paging messages. Therefore, by utilizing the physical identifier list can save the UE 221 time in searching for femto nodes and free up resources for additional purposes.

In one embodiment, the UE 221 can use the physical identifier list to speed up the time it takes to search for femto nodes, which allows for example, a user of the UE 221 to view details of femto nodes more quickly, such as for a manual selection of a femto node. The UE 221 may have one or more physical identifier lists received from one or more macro nodes. A user of the UE 221 may initiate a manual femto node selection procedure on the UE 221. During this time, the UE 221 may be in an idle mode where it is not in active communication (e.g., a voice call) with a node. The UE 221 may use the physical identifier lists to determine over which frequencies femto nodes are communicating. The UE 221 may scan only the frequencies with femto nodes and ignore scanning frequencies without femto nodes. For example, there may be femto nodes communicating on frequencies F1 and F2, but not on frequency F3. Accordingly, the UE 221 may perform a scan of F1 and F2, but not F3 for physical identifiers. During the scan, the UE 221 may detect physical identifiers for one or more nodes on the frequencies scanned. Using the physical identifier list, the UE 221 determines which detected physical identifiers are associated with femto nodes. The UE 221 then reads SIBs from only the detected physical identifiers associated with femto nodes. In another embodiment, the UE 221 reads SIBs from only the detected physical identifiers associated with femto nodes that transmit the SIBs with a sufficiently strong signal-to-noise ratio (SNR) (e.g., a SNR above a threshold level) that the UE 221 determines is sufficient for communication. The UE 221 may then display information related to the femto nodes for which SIBs were read to a user on a display of the UE 221. The information related to the femto nodes may include any combination of an identity of the femto nodes, a name of the femto node, an access mode of the femto node, signal strength of the femto node, etc. A user of the UE 221 may use this information to select a femto node to communicate with, such as by handing-off to the selected femto node.

The UE 221 may further use the physical identifier list to more efficiently perform an active hand-in from one node to another node. For example, the UE 221 may be in an active mode, such as actively in a call with another UE and in communication with the macro node 205 over frequency F1. A controller, such as the macro node 205, on the communication network 240 may instruct the UE 221 to perform an intra-frequency search for neighboring nodes to hand-in. The UE 221 may scan frequency F1 to detect physical layer identifiers transmitted by nodes within communication distance of the UE 221. The UE 221 may then use the physical layer identifier list to selectively read the SIBs of one or more of the detected nodes. In one embodiment, if the UE 221 does not have a subscription to a femto node, the UE 221 may avoid reading the SIBs of nodes with physical identifiers that are associated with femto nodes. If the UE 221 does have a subscription to a femto node and is configured to hand-in to any type of node, the UE 221 may read the SIBs of all nodes. In one embodiment, if the UE 221 has a subscription to a femto node and is configured to hand-in to only a femto node, the UE 221 may read the SIBs of only femto nodes. In another embodiment, if the UE 221 has a subscription to a femto node and is configured to hand-in to only a femto node, the UE 221 may read only the SIBs of femto nodes with physical layer identifiers that match the physical layer identifiers of femto nodes for which the UE 221 has a subscription. For the above embodiments the UE 221 may further read SIBs from only the detected physical identifiers associated with femto nodes that transmit the SIBs with a sufficiently strong signal-to-noise ratio (SNR) (e.g., a SNR above a threshold level) that the UE 221 determines is sufficient for communication. Utilizing the SIBs of the femto nodes, the UE 221 can determine whether or not it is subscribed with each of the femto nodes. In some embodiments, the UE 221 then reports the nodes detected to the macro node 205. In one embodiment, the UE 221 reports all of the nodes detected to the macro node 205. In another embodiment, the UE 221 reports only femto nodes and/or macro nodes with which the UE 221 is authorized to access. The macro node 205 may then facilitate active handover to one of the reported nodes. For example, the macro node 205 may direct the UE 221 to handover to the node from which the UE 221 receives a signal with the highest signal-to-noise ratio that the UE 221 is authorized to access. One of ordinary skill in the art should recognize that the above described embodiment could similarly be used for active hand-in from a femto node to another femto node.

In another embodiment, the UE 221 may further use the physical identifier list to more efficiently perform a cell reselection. For example, the UE 221 may be in idle mode and camping on the macro node 205 over a frequency F1. The UE 221 may then determine it needs to perform a cell reselection and camp on a different node. For example, the signal conditions between the UE 221 and the macro node 205 may degrade. Accordingly, the UE 221 may scan one or more frequencies for a node to camp on. The UE 221 may perform idle handoff (e.g., cell reselection) and handoff from the macro node 205 to the other node to camp on. In one embodiment, the UE 221 may only scan frequencies other than the frequency F1 over which the macro node 205 communications. In another embodiment, the UE 221 may only scan the same frequency F1 over which the macro node 205 communicates. In yet another embodiment, the UE 221 may scan only the frequencies with femto nodes and ignore scanning frequencies without femto nodes. For example, there may be femto nodes communicating on frequencies F1 and F2, but not on frequency F3, according to the physical identifier list. Accordingly, the UE 221 may perform a scan of F1 and F2, but not F3 for physical identifiers. During the scan, the UE 221 may detect physical identifiers for one or more nodes on the frequencies scanned.

As part of the cell reselection process, the UE 221 may then use the physical layer identifier list to selectively read the SIBs of one or more of the detected nodes. If the UE 221 does not have a subscription to a femto node, the UE 221 may avoid reading the SIBs of nodes with physical identifiers that are associated with femto nodes. If the UE 221 does have a subscription to a femto node and is configured to handoff to any type of node, the UE 221 may read the SIBs of all nodes. In one embodiment, if the UE 221 has a subscription to a femto node and is configured to handoff to only a femto node, the UE 221 may read the SIBs of only femto nodes. In another embodiment, if the UE 221 has a subscription to a femto node and is configured to handoff to only a femto node, the UE 221 may read only the SIBs of femto nodes with physical layer identifiers that match the physical layer identifiers of femto nodes for which the UE 221 has a subscription. For the above embodiments the UE 221 may further read SIBs from only the detected physical identifiers associated with femto nodes that transmit the SIBs with a sufficiently strong signal-to-noise ratio (SNR) (e.g., a SNR above a threshold level) that the UE 221 determines is sufficient for communication. Utilizing the SIBs of the femto nodes, the UE 221 can determine whether or not it is subscribed with each of the femto nodes. The UE 221 may then perform a cell reselection to an appropriate node based on the SIBs read by the UE 221. One of ordinary skill in the art should recognize that the above described embodiment could similarly be used for idle handoff from a femto node to another femto node.

For convenience, the disclosure herein describes various functionalities related to a femto node. It should be appreciated, however, that a pico node may provide the same or similar functionality for a larger coverage area. For example, a pico node may be restricted, a home pico node may be defined for a given user equipment, and so on.

A wireless multiple-access communication system may simultaneously support communication for multiple wireless user equipments. As mentioned above, each user equipment may communicate with one or more nodes via transmissions on the forward and reverse links. The forward link (or downlink) refers to the communication link from the node to the user equipment, and the reverse link (or uplink) refers to the communication link from the user equipment to the node. This communication link may be established via a single-in-single-out system, a multiple-in-multiple-out (“MIMO”) system, or some other type of system.

A MIMO system employs multiple (NT) transmit antennas and multiple (NR) receive antennas for data transmission. A MIMO channel formed by the NT transmit and NR receive antennas may be comprise NS independent channels, which are also referred to as spatial channels, where NS≦min {NT, NR}. Each of the NS independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables a device (e.g., a node, a user equipment, etc.) to extract a transmit beam-forming gain on the forward link when multiple antennas are available at the device.

The teachings herein may be incorporated into a device (e.g., a node, a user equipment, etc.) employing various components for communicating with at least one other device.

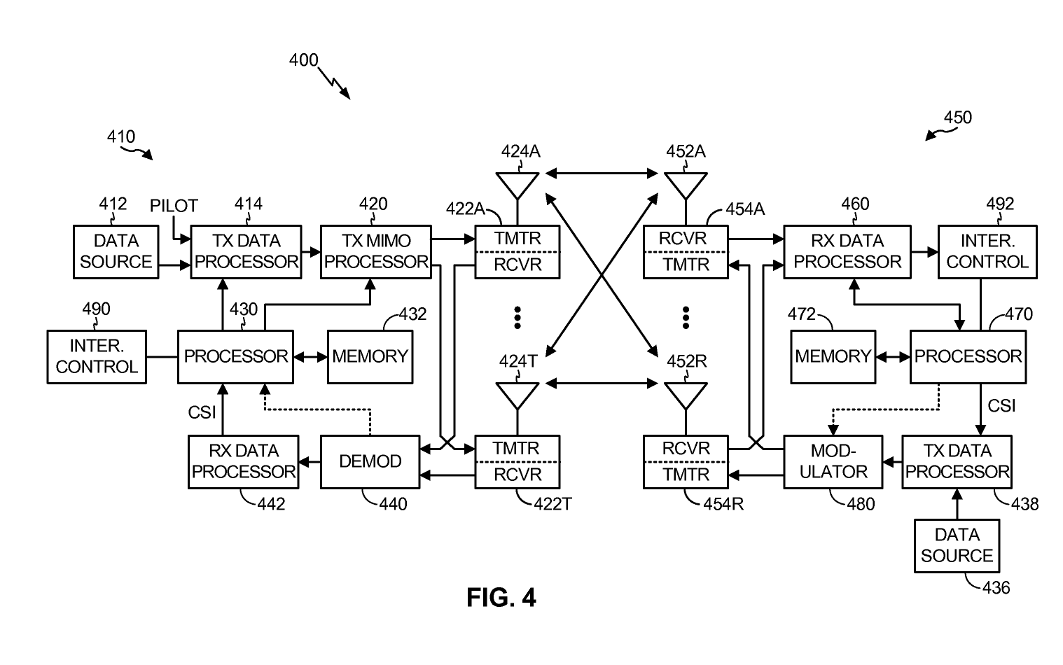

FIG. 4 is a functional block diagram of a first exemplary femto node 410 and a first exemplary user equipment 450 in one of the communication networks of FIG. 2. As shown, a MIMO system 400 comprises a femto node 410 and a user equipment 450 (e.g., the UE 222). At the femto node 410, traffic data for a number of data streams is provided from a data source 412 to a transmit (“TX”) data processor 414.

In one embodiment, each data stream is transmitted over a respective transmit antenna. The TX data processor 414 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 430. A data memory 432 may store program code, data, and other information used by the processor 430 or other components of the femto node 410.

The modulation symbols for all data streams are then provided to a TX MIMO processor 420, which may further process the modulation symbols (e.g., for OFDM). The TX MIMO processor 420 then provides NT modulation symbol streams to NT transceivers (“XCVR”) 422A through 422T. In some aspects, the TX MIMO processor 420 applies beam-forming weights to the symbols of the data streams and to the antenna from which the symbol is being transmitted.

Each transceiver 422 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 422A through 422T are then transmitted from NT antennas 424A through 424T, respectively.

At the femto node 450, the transmitted modulated signals are received by NR antennas 452A through 452R and the received signal from each antenna 452 is provided to a respective transceiver (“XCVR”) 454A through 454R. Each transceiver 454 conditions (e.g., filters, amplifies, and downconverts) a respective received signal, digitizes the conditioned signal to provide samples, and further processes the samples to provide a corresponding “received” symbol stream.

A receive (“RX”) data processor 460 then receives and processes the NR received symbol streams from NR transceivers 454 based on a particular receiver processing technique to provide NT “detected” symbol streams. The RX data processor 460 then demodulates, deinterleaves, and decodes each detected symbol stream to recover the traffic data for the data stream. The processing performed by the RX data processor 460 is complementary to that performed by the TX MIMO processor 420 and the TX data processor 414 at the femto node 410.

A processor 470 periodically determines which pre-coding matrix to use (discussed below). The processor 470 formulates a reverse link message comprising a matrix index portion and a rank value portion. A data memory 472 may store program code, data, and other information used by the processor 470 or other components of the femto node 450.

The reverse link message may comprise various types of information regarding the communication link and/or the received data stream. The reverse link message is then processed by a TX data processor 438. The TX data processor 438 also receives traffic data for a number of data streams from a data source 436. The modulator 480 modulates the data streams. Further, the transceivers 454A through 454R condition the data streams and transmits the data streams back to the femto node 410.

At the femto node 410, the modulated signals from the femto node 450 are received by the antennas 424. Further, the transceivers 422 condition the modulated signals. A demodulator (“DEMOD”) 440 demodulates the modulated signals. A RX data processor 442 processes the demodulated signals and extracts the reverse link message transmitted by the femto node 450. The processor 430 then determines which pre-coding matrix to use for determining the beam-forming weights. Further, the processor 430 processes the extracted message.

Further, the femto node 410 and/or the femto node 450 may comprise one or more components that perform interference control operations as taught herein. For example, an interference (“INTER”) control component 490 may cooperate with the processor 430 and/or other components of the femto node 410 to send/receive signals to/from another device (e.g., femto node 450) as taught herein. Similarly, an interference control component 492 may cooperate with the processor 470 and/or other components of the femto node 450 to send/receive signals to/from another device (e.g., femto node 410). It should be appreciated that for each femto node 410 and 450 the functionality of two or more of the described components may be provided by a single component. For example, a single processing component may provide the functionality of the interference control component 490 and the processor 430. Further, a single processing component may provide the functionality of the interference control component 492 and the processor 470.

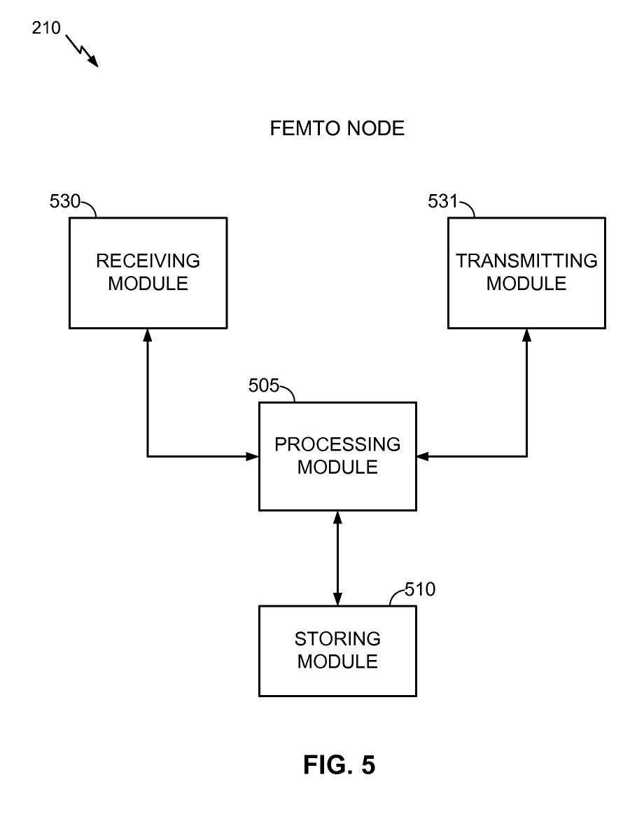

FIG. 5 is a functional block diagram of a second exemplary femto node 210 in one of the communication networks of FIG. 2. As discussed above with respect to FIG. 2, the femto node 210 may transmit one or more pilot signals comprising a physical layer identifier of the femto node 210. Further, the femto node 210 may transmit SIBs comprising information about the femto node 210. The femto node 210 may comprise a transmitting module 531. The transmitting module 531 may transmit the one or more pilot signals, SIBs, physical layer identifier lists, or other outbound messages to other devices. The femto node 210 may also comprise a receiving module 530 configured to receive inbound messages from devices such as the UE 221. The receiving module 530 and the transmitting module 531 may be coupled to the processing module 505. The receiving module 530 and the transmitting module 531 may also be configured to pass an outbound message to, and receive an inbound wired message from, the network 240. The receiving module 530 may pass the inbound wired message to the processing module 505 for processing. The processing module 505 may process and pass the wired outbound message to the transmitting module 531 for transmission to the network 240. The processing module 505 may be configured to process the inbound and outbound wireless messages coming from or going to the UE 221 via the receiving module 530 and the transmitting module 531. The processing module 505 may be further configured to generate the one or more pilot signals for transmission via the transmitting module 531. The processing module 505 may also be configured to control other components of the femto node 210.

The processing module 505 may further be coupled, via one or more buses, to a storing module 510. The processing module 505 may read information from or write information to the storing module 510. For example, the storing module 510 may be configured to store inbound our outbound messages before, during, or after processing. In particular, the storing module 510 may be configured to store information indicative of the pilot signal(s) assigned to the femto node 210, system information of the femto node 210, and/or physical layer identifier list(s).

The receiving module 530 and the transmitting module 531 may comprise an antenna and a transceiver. The transceiver may be configured to modulate/demodulate the wireless outbound/inbound messages going to or coming from UE 221 respectively. The wireless outbound/inbound messages may be transmitted/received via the antenna. The antenna may be configured to send and/or receive the outbound/inbound wireless messages to/from the UE 221 over one or more channels. The outbound/inbound messages may comprise voice and/or data-only information (collectively referred to herein as “data”). The receiving module 530 may demodulate the data received. The transmitting module 531 may modulate data to be sent from the femto node 210. The processing module 505 may provide data to be transmitted.

The receiving module 530 and the transmitting module 531 may further comprise a modem. The modem may be configured to modulate/demodulate the outbound/inbound wired messages going to or coming from the network 240. The receiving module 530 may demodulate data received. The demodulated data may be transmitted to the processing module 505. The transmitting module 531 may modulate data to be sent from the femto node 210. The processing module 505 may provide data to be transmitted.

The storing module 510 may comprise processing module cache, including a multi-level hierarchical cache in which different levels have different capacities and access speeds. The storing module 510 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives.

Although described separately, it is to be appreciated that functional blocks described with respect to the femto node 210 need not be separate structural elements. For example, the processing module 505 and the storing module 510 may be embodied in a single chip. The processing module 505 may additionally, or in the alternative, contain memory, such as registers. Similarly, one or more of the functional blocks or portions of the functionality of various blocks may be embodied in a single chip. Alternatively, the functionality of a particular block may be implemented on two or more chips.

One or more of the functional blocks and/or one or more combinations of the functional blocks described with respect to the femto node 210, such as the processing module 505, may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described with respect to the femto node 210 may also be implemented as a combination of computing devices, e.g., a combination of a DSP and a microprocessor, a plurality of microprocessors, one or more microprocessors in conjunction with a DSP communication, or any other such configuration.

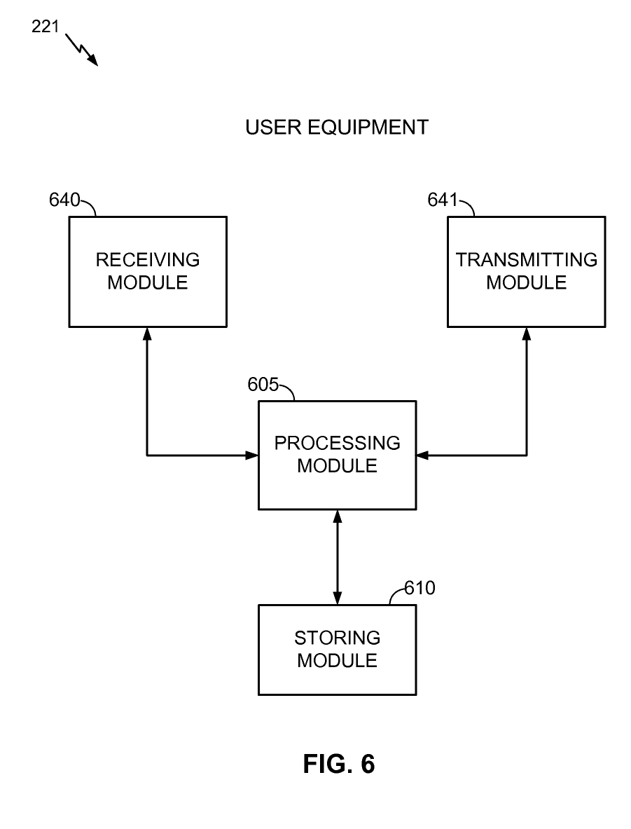

FIG. 6 is a functional block diagram of a second exemplary user equipment 221 in one of the communication networks of FIG. 2. As discussed above, the UE 221 may be a mobile phone. The UE 221 may be used communicate information to and/or from the femto node 210 and/or the macro node 205.

The UE 221 may comprise a processing module 605 configured to process information for storage, transmission, and/or for the control of other components of the UE 221. The processing module 605 may further be coupled to a storing module 610. The processing module 605 may read information from or write information to the storing module 610. The storing module 610 may be configured to store information before, during or after processing. The processing module 605 may also be coupled to a receiving module 640 and a transmitting module 641. The receiving module 640 may be configured to receive an inbound wireless message from the femto node 210 (e.g., pilot signals, SIBs, physical layer identifier lists, etc.) or the macro node 205. The transmitting module 641 may be configured to transmit an outbound wireless message to the femto node 210 or the macro node 205 (e.g., MRMs).

The inbound wireless message may be passed to the processing module 605 for processing. For example, pilot signals received by the receiving module 640 may be passed to the processing module 605. The processing module 605 may generate a MRM to report the pilot signals. The MRM may comprise an indication of the offsets of the pilot signals. The MRM may further comprise the received strength of the pilot signals. The processing module 605 may pass the MRM to transmitting module 641 for transmission. Further, SIBs and/or physical layer identifier lists may be passed to the processing module 605. The processing module 605 may utilize this information to perform the functions as described above with respect to FIG. 2.

The receiving module 640 and the transmitting module 641 may comprise an antenna and a transceiver. The transceiver may be configured to modulate/demodulate the outbound/inbound wireless messages going to or coming from femto node 210 and the macro node 205. The outbound/inbound wireless messages may be transmitted/received via the antenna. The antenna may be configured to communicate with the femto node 210 and macro node 205 over one or more channels. The outbound/inbound wireless message may comprise voice and/or data-only information (collectively referred to herein as “data”). The receiving module 640 may demodulate the data received. The receiving module 640 may modulate data to be sent from the UE 221. The processing module 605 may provide data to be transmitted.

The storing module 610 may comprise processing module cache, including a multi-level hierarchical cache in which different levels have different capacities and access speeds. The storing module 610 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives.

Although described separately, it is to be appreciated that functional blocks described with respect to the user equipment 221 need not be separate structural elements. For example, the processing module 605 and the storing module 610 may be embodied in a single chip. The processing module 605 may additionally, or in the alternative, contain memory, such as registers. Similarly, one or more of the functional blocks or portions of the functionality of various blocks may be embodied in a single chip. Alternatively, the functionality of a particular block may be implemented on two or more chips.

One or more of the functional blocks and/or one or more combinations of the functional blocks described with respect to the UE 221, such as the processing module 605 may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described with respect to the UE 221 may also be implemented as a combination of computing devices, e.g., a combination of a DSP and a microprocessor, a plurality of microprocessors, one or more microprocessors in conjunction with a DSP communication, or any other such configuration.

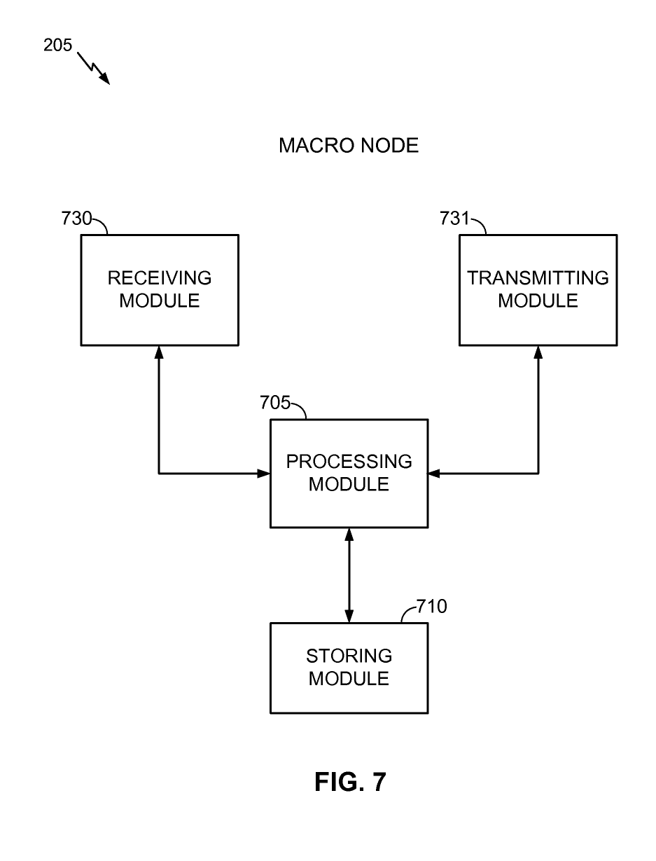

FIG. 7 is a functional block diagram of an exemplary macro node 205 in one of the communication networks of FIG. 2. As discussed above with respect to FIG. 2, the macro node 205 may communicate with the UE 221 to provide the UE 221 with access to the network 240. The macro node 205 may comprise a receiving module 730 configured to receive inbound messages (e.g., MRM) from devices such as the UE 221. The macro node 205 may also comprise a transmitting module 731. The transmitting module 731 may transmit outbound messages (e.g., instruction to handoff, SIBs, pilot signals, physical layer identifier lists, etc.) to other devices. The receiving module 730 and the transmitting module 731 may be coupled to the processing module 705. The receiving module 730 and the transmitting module 731 may also be configured to pass an outbound message to, and receive an inbound wired message from, the network 240. The receiving module 730 may pass the inbound wired message to the processing module 705 for processing. The processing module 705 may process and pass the wired outbound message to the transmitting module 731 for transmission to the network 240. The processing module 705 may be configured to process the inbound and outbound wireless messages coming from or going to the UE 221 via the receiving module 730 and the transmitting module 731. The processing module 705 may also be configured to control other components of the femto node 210.

The processing module 705 may further be coupled, via one or more buses, to a storing module 710. The processing module 705 may read information from or write information to the storing module 710. For example, the storing module 710 may be configured to store inbound our outbound messages before, during, or after processing. In particular, the storing module 710 may be configured to store information indicative of the pilot signal(s) assigned to the macro node 205, system information of the macro node 205, and/or physical layer identifier list(s). Further, the storing module 710 may be configured to store information (e.g., a database, table, etc.) indicative of the pilot signal(s) and/or offset differences assigned to various femto nodes.

The processing module 705 may be further configured to process a MRM received from a UE via the receiving module 730. For example, the macro node 205 may receive via the receiving module 730 a MRM comprising one or more pilot signals sent by the UE 221. The processing module 705 may then access a data (e.g., a database) stored in the storing module 710 that indicates the pilot signal(s) and/or offset differences assigned to various femto nodes (e.g., the femto nodes in the macro area 230 which the macro node 205 serves). In another embodiment the processing module 705 may, via the receiving module 730 and the transmitting module 731, access such data on a server connected to the network 240.

The processing module 735 may further determine the identity of the femto node 210 that sent the pilot signals to the UE 221 based on the accessed data. The accessed data may further indicate whether the UE 221 is provisioned to communicate with the femto node 210. In one embodiment, the processing module 735 may further determine whether the strength of the pilot signals are above a threshold level. Based on the determined information, the processing module 735 may generate a message directing the UE 221 to handoff to the femto node 210 and begin communicating with the femto node 210. The processing module 735 may pass the message to the transmitting module 731, which sends the message to the UE 221.

The receiving module 730 and the transmitting module 731 may comprise an antenna and a transceiver. The transceiver may be configured to modulate/demodulate the wireless outbound/inbound messages going to or coming from UE 221 respectively. The wireless outbound/inbound messages may be transmitted/received via the antenna. The antenna may be configured to send and/or receive the outbound/inbound wireless messages to/from the UE 221 over one or more channels. The outbound/inbound messages may comprise voice and/or data-only information (collectively referred to herein as “data”). The receiving module 730 may demodulate the data received. The transmitting module 731 may modulate data to be sent from the macro node 205. The processing module 705 may provide data to be transmitted.

The receiving module 730 and the transmitting module 731 may further comprise a modem. The modem may be configured to modulate/demodulate the outbound/inbound wired messages going to or coming from the network 240. The receiving module 730 may demodulate data received. The demodulated data may be transmitted to the processing module 705. The transmitting module 731 may modulate data to be sent from the macro node 205. The processing module 705 may provide data to be transmitted.

The storing module 710 may comprise processing module cache, including a multi-level hierarchical cache in which different levels have different capacities and access speeds. The storing module 710 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives.

Although described separately, it is to be appreciated that functional blocks described with respect to the macro node 710 need not be separate structural elements. For example, the processing module 705 and the storing module 710 may be embodied in a single chip. The processing module 705 may additionally, or in the alternative, contain memory, such as registers. Similarly, one or more of the functional blocks or portions of the functionality of various blocks may be embodied in a single chip. Alternatively, the functionality of a particular block may be implemented on two or more chips.

One or more of the functional blocks and/or one or more combinations of the functional blocks described with respect to the macro node 205, such as the processing module 705, may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described with respect to the macro node 205 may also be implemented as a combination of computing devices, e.g., a combination of a DSP and a microprocessor, a plurality of microprocessors, one or more microprocessors in conjunction with a DSP communication, or any other such configuration.

The functionality described herein (e.g., with regard to one or more of the accompanying figures) may correspond in some aspects to similarly designated “means for” functionality in the appended claims. Referring to FIGS. 5-8, the femto node 210, the UE 221, and the macro node 205 are represented as a series of interrelated functional modules.

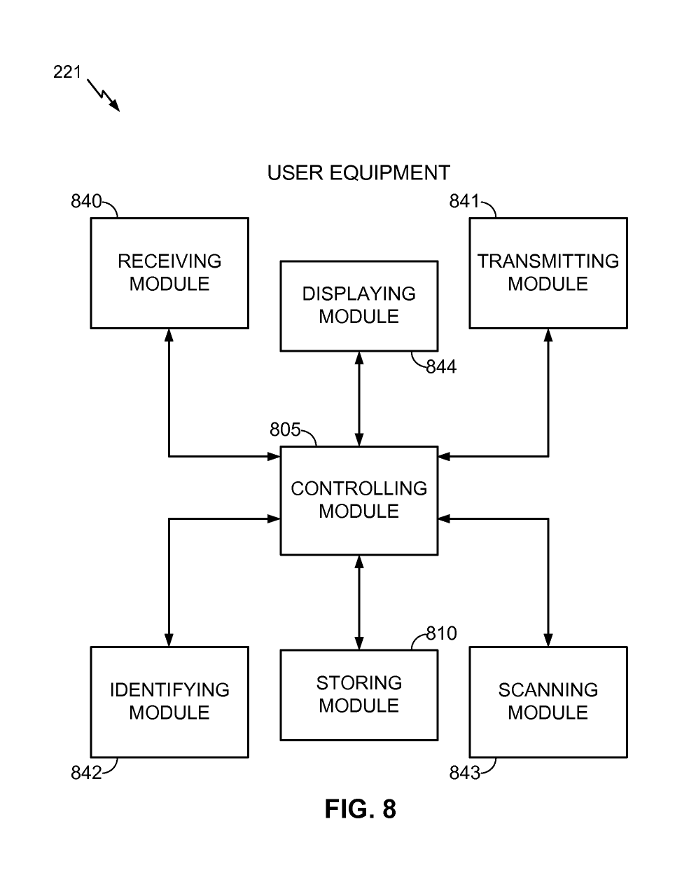

FIG. 8 is a functional block diagram of a third exemplary user equipment in one of the communication networks of FIG. 2. As shown, the UE 221 may comprise a controlling module 805, a storing module 810, a receiving module 840, a transmitting module 841, an identifying module 842, a scanning module 843, and a displaying module 844. The controlling module 805 may correspond at least in some aspects to, for example, a processor or a processing module as discussed herein. The storing module 810 may correspond at least in some aspects to, for example, a memory or a storing module as discussed herein. The receiving module 840 may correspond at least in some aspects to, for example, a receiver or a receiving module as discussed herein. The transmitting module 841 may correspond at least in some aspects to, for example, a transmitter or a transmitting module as discussed herein. The identifying module 842 may correspond at least in some aspects to, for example, a processor or a processing module as discussed herein. The scanning module 843 may correspond at least in some aspects to, for example, a receiver or a receiving module as discussed herein. The displaying module 844 may correspond at least in some aspects to, for example, a display as discussed herein.

The functionality of the modules of FIGS. 5-8 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein.

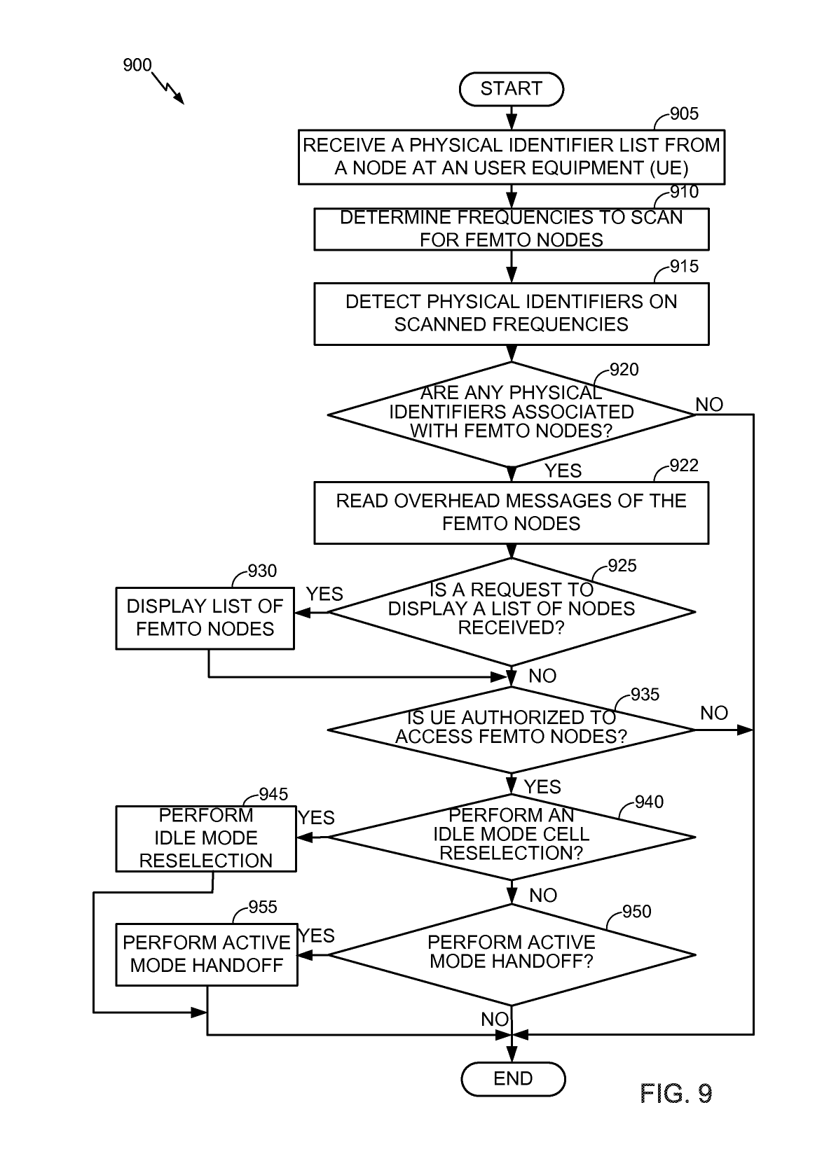

FIG. 9 is a flow chart illustrating an exemplary process of a user equipment with a femto cell subscription searching for femto nodes shown in FIGS. 4 and 5. At a first step 905, the UE 221 receives a physical identifier list from a node such as the macro node 205 or the femto node 210. Continuing at a step 910, the UE 221 determines one or more frequencies to scan for femto nodes based on the physical identifier list. Further, at a step 915, the UE 221 detects physical identifiers on the scanned frequencies.

Continuing at a step 920, the UE 221 determines if any of the detected physical identifiers are associated with femto nodes based on the physical identifier list. If at the step 920, the UE 221 determines none of the detected physical identifiers are associated with femto nodes, the process 900 ends. If at the step 920, the UE 221 determines at least one of the detected physical identifiers is associated with femto nodes, the process 900 continues to a step 922.

At the step 922, the UE 221 reads the overhead messages (e.g., SIBs) broadcast by the femto nodes associated with the detected physical identifiers. Further, at the step 925, the UE 221 determines if input has been received at the UE 221 (e.g., from a user of the UE 221) requesting a list of femto nodes the UE 221 may access. If at the step 925 the UE 221 determines an input is not received, the process continues to a step 935. If at the step 925 the UE 221 determines an input is received, the process continues to a step 930, where the UE 221 displays information indicative of the femto nodes associated with the detected physical identifiers. The process then continues to a step 935.

At the step 935, the UE 221 determines if it is authorized to access the femto node(s) associates with the at least one of the detected physical identifier based on the SIBs. If at the step 935 the UE 221 determines it is not authorized to access the femto nodes, the process 900 ends. If at the step 935 the UE 221 determines it is authorized to access at least one of the femto nodes, the process 900 continues to a step 940.

At the step 940, the UE 221 determines if it is in an idle mode and should perform a cell reselection to one of the femto nodes the UE 221 determined it is authorized to access at the step 925. For example, the UE 221 may perform a idle mode cell reselection due to input received from a user of the UE 221 or due to degradation of signal quality. If at the step 940, the UE 221 determines it should perform a cell reselection to one of the femto nodes the UE 221 determined it is authorized to access at the step 925, the process 900 continues to the step 945, where the cell reselection is performed. The process 900 then ends. If at the step 940, the UE 221 determines it should not perform an idle mode cell reselection to one of the femto nodes the UE 221 determined it is authorized to access at the step 925, the process 900 continues to a step 950.

At the step 950, the UE 221 determines if it is in an active mode and should perform an active mode handoff to one of the femto nodes the UE 221 determined it is authorized to access at the step 925. If at the step 950, the UE 221 determines it should perform an active mode handoff to one of the femto nodes the UE 221 determined it is authorized to access at the step 925, the process 900 continues to the step 955, where the an active mode handoff is performed. The process 900 then ends. If at the step 950, the UE 221 determines it should not perform an active mode handoff to one of the femto nodes the UE 221 determined it is authorized to access at the step 925, the process 900 ends.

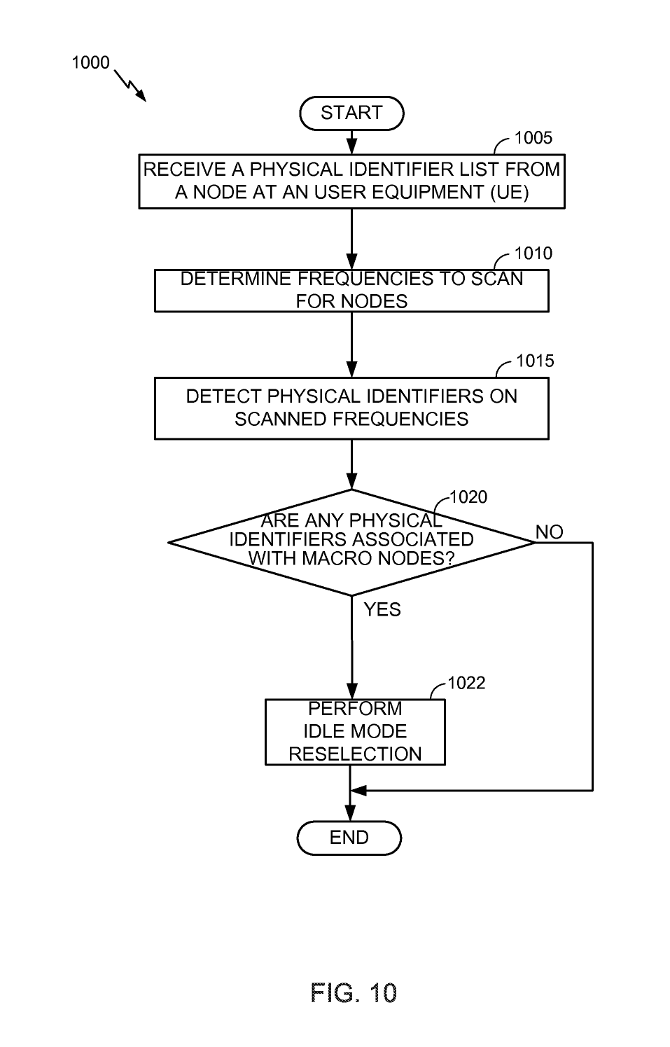

FIG. 10 is a flow chart illustrating an exemplary process of a user equipment in idle mode without a femto cell subscription searching for nodes shown in FIG. 7. At a first step 1005, the UE 221 receives a physical identifier list from a node such as the macro node 205. Continuing at a step 1010, the UE 221 determines one or more frequencies to scan for nodes based on the physical identifier list. Further, at a step 1015, the UE 221 detects physical identifiers on the scanned frequencies.

Continuing at a step 1020, the UE 221 determines if any of the detected physical identifiers are associated with nodes other than femto nodes based on the physical identifier list. If at the step 1020, the UE 221 determines none of the detected physical identifiers are associated with nodes other than femto nodes, the process 1000 ends. If at the step 1020, the UE 221 determines at least one of the detected physical identifiers is associated with a node other than a femto node, the process 1000 continues to a step 1022. Further, at the step 1022, the UE 221 performs a cell reselection procedure to one of the nodes other than a femto node associated with a detected physical identifier. The process 1000 then ends.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

The embodiments presented herein and other embodiments are further described in greater detail in the attached Appendix. While the specification describes particular examples of the present invention, those of ordinary skill can devise variations of the present invention without departing from the inventive concept. For example, the teachings herein refer to circuit-switched network elements but are equally applicable to packet-switched domain network elements.

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A wireless communication device comprising:
a transceiver configured to:
store data indicative of physical identifiers of one or more femto nodes; and
scan one or more frequencies for transmissions from one or more nodes, the transmission comprising physical identifiers of the one or more nodes; and a processor configured to:
identify a type of each of the one or more nodes based at least in part on said data and the physical identifiers of the one or more nodes; and
selectively and based on the identified types control the transceiver to read system information messages from the one or more nodes that are identified as femto nodes.

2. The wireless communication device of claim 1, further comprising a display configured to display a list of the one or more nodes that are identified as femto nodes for manual selection.

3. The wireless communication device of claim 1, wherein the processor is further configured to control the transceiver to perform an active handover to a first node of the one or more nodes.

4. The wireless communication device of claim 3, wherein the first node comprises a femto node.

5. The wireless communication device of claim 3, wherein the first node comprises a macro node.

6. The wireless communication device of claim 1, wherein the processor is further configured to control the transceiver to perform an idle mode reselection to a first node of the one or more nodes.

7. The wireless communication device of claim 6, wherein the first node comprises a femto node.

8. The wireless communication device of claim 6, wherein the first node comprises a macro node.

9. The wireless communication device of claim 1, wherein said data comprises physical identifiers of one or more femto nodes configured to communicate on a plurality of frequencies.

10. The wireless communication device of claim 1, wherein said data comprises a primary scrambling codes list.

11. The wireless communication device of claim 1, wherein the physical identifiers comprise primary scrambling codes.

12. The wireless communication device of claim 1, wherein system information messages comprise system information broadcasts.

13. A method for communicating in a wireless network, the method comprising:
storing data indicative of physical identifiers of one or more femto nodes;
scanning one or more frequencies for transmissions from one or more nodes, the transmission comprising physical identifiers of the one or more nodes;
identifying a type of each of the one or more nodes based at least in part on said data and the physical identifiers of the one or more nodes; and
selectively and based on the identified types read system information messages from the one or more nodes that are identified as femto nodes.

14. The method of claim 13, further comprising displaying a list of the one or more nodes that are identified as femto nodes for manual selection.

15. The method of claim 13, further comprising performing an active handover to a first node of the one or more nodes.

16. The method of claim 15, wherein the first node comprises a femto node.

17. The method of claim 15, wherein the first node comprises a macro node.

18. The method of claim 13, further comprising performing an idle mode reselection to a first node of the one or more nodes.

19. The method of claim 18, wherein the first node comprises a femto node.

20. The method of claim 18, wherein the first node comprises a macro node.

21. The method of claim 13, wherein said data comprises physical identifiers of one or more femto nodes configured to communicate on a plurality of frequencies.

22. The method of claim 13, wherein said data comprises a primary scrambling codes list.

23. The method of claim 13, wherein the physical identifiers comprise primary scrambling codes.

24. The method of claim 13, wherein system information messages comprise system information broadcasts.

25. A wireless communication device comprising:
means for storing data indicative of physical identifiers of one or more femto nodes;
means for scanning one or more frequencies for transmissions from one or more nodes, the transmission comprising physical identifiers of the one or more nodes;
means for identifying a type of each of the one or more nodes based at least in part on said data and the physical identifiers of the one or more nodes; and
means for selectively and based on the identified types controlling the means for receiving to read system information messages from the one or more nodes that are identified as femto nodes.

26. The wireless communication device of claim 25, further comprising means for displaying a list of the one or more nodes that are identified as femto nodes for manual selection.

27. The wireless communication device of claim 25, further comprising means for controlling an active handover to a first node of the one or more nodes.

28. The wireless communication device of claim 27, wherein the first node comprises a femto node.

29. The wireless communication device of claim 27, wherein the first node comprises a macro node.

30. The wireless communication device of claim 25, further comprising means for controlling an idle mode reselection to a first node of the one or more nodes.

31. The wireless communication device of claim 30, wherein the first node comprises a femto node.

32. The wireless communication device of claim 30, wherein the first node comprises a macro node.

33. The wireless communication device of claim 25, wherein said data comprises physical identifiers of one or more femto nodes configured to communicate on a plurality of frequencies.

34. The wireless communication device of claim 25, wherein said data comprises a primary scrambling codes list.

35. The wireless communication device of claim 25, wherein the physical identifiers comprise primary scrambling codes.

36. The wireless communication device of claim 25, wherein system information messages comprise system information broadcasts.

37. A computer program product, comprising:
computer-readable medium comprising:
code for causing a computer to store data indicative of physical identifiers of one or more femto nodes;
code for causing a computer to scan one or more frequencies for transmissions from one or more nodes, the transmission comprising physical identifiers of the one or more nodes;
code for causing a computer to identify a type of each of the one or more nodes based at least in part on said data and the physical identifiers of the one or more nodes; and
code for causing a computer to selectively and based on the identified types read system information messages from the one or more nodes that are identified as femto nodes.

38. The computer program product of claim 37, wherein the computer-readable medium further comprises code for causing a computer to display a list of the one or more nodes that are identified as femto nodes for selection.

39. The computer program product of claim 37, wherein the computer-readable medium further comprises code for causing a computer to perform an active handover to a first node of the one or more nodes.

40. The computer program product of claim 39, wherein the first node comprises a femto node.

41. The computer program product of claim 39, wherein the first node comprises a macro node.

42. The computer program product of claim 37, wherein the computer-readable medium further comprises code for causing a computer to perform an idle mode reselection to a first node of the one or more nodes.

43. The computer program product of claim 42, wherein the first node comprises a femto node.

44. The computer program product of claim 42, wherein the first node comprises a macro node.

45. The computer program product of claim 37, wherein said data comprises physical identifiers of one or more femto nodes configured to communicate on a plurality of frequencies.

46. The computer program product of claim 37, wherein said data comprises a primary scrambling codes list.

47. The computer program product of claim 37, wherein the physical identifiers comprise primary scrambling codes.

48. The computer program product of claim 37, wherein system information messages comprise system information broadcasts.
